(19) United States
(12) Patent Application Publication
(10) Pub. No.: US 2007/0195218 A1
(43) Pub. Date: Aug. 23, 2007

(54) Display substrate, display panel having the same and method of manufacturing the same

(76) Inventor: Min Kang, Seoul (KR)

Correspondence Address: David W. Heid;MacPHERSON KWOK CHEN & HEID LLP, Suite 226, 1762 Technology Drive, San Jose, CA, 95110, US

(21) Appl. No.: 11/703,407

(22) Filed: Feb. 6, 2007

(30) Foreign Application Priority Data
Feb. 7, 2006 (KR) 2006-11798

(51) Int. Cl. G02F 1/1333

(52) U.S. Cl. 349/56

(57) ABSTRACT

A display substrate includes a base substrate and a color-converting layer. The display substrate has a first surface and a second surface which is opposite to the first surface. The color converting layer is positioned on the first surface of the display substrate. When the display substrate is utilized in a display panel, the second surface faces a liquid crystal layer. Thus, impurities such as ionic impurities from the color-converting layer may be prevented from migrating into the liquid crystal layer.

### CROSS-REFERENCE TO RELATED APPLICATIONS

This application relies for priority upon Korean Patent Application No. 10-2006-0011798 filed on Feb. 7, 2006, the contents of which are herein incorporated by reference in its entirety.

### BACKGROUND OF THE INVENTION

1. Field of the Invention

The present invention relates to a display substrate, a display panel having the display substrate and a method of manufacturing the display substrate. More particularly, the present invention relates to a display substrate for reducing impurities which could migrate into a liquid crystal layer.

2. Description of the Related Art

In general, a liquid crystal display apparatus includes a liquid crystal display panel and a driving apparatus to drive the liquid crystal display panel. The liquid crystal display panel includes a lower substrate, an upper substrate and a liquid crystal layer interposed between the lower substrate and the upper substrate. The lower substrate includes a plurality of pixel electrodes and a plurality of switching elements electrically connected to the pixel electrodes. Typically the upper substrate includes a common electrode and a plurality of color filters corresponding to the pixel electrodes.

In order to prevent the liquid crystal from being damaged, the liquid crystal display apparatus is operated by using alternate driving techniques, such as a dot inversion, a 2-dot inversion, or a line inversion. Such a driving method causes an alternative electric field between the pixel electrode and the common electrode and between the common electrode and each of a source line and a gate line.

The lower substrate and the upper substrate include alignment films directly contacting the liquid crystal layer. The alignment films do not perfectly prevent inflow of impurities such as ions. Thus, ions flow into the liquid crystal layer from the color filters, an overcoating layer covering the color filters and an insulating layer covering the pixel electrode.

The ions are moved up and down by the alternative electric fields so that the ions accumulate near the alignment films. Furthermore, a lateral force due to a difference between gray scale voltages applied to the pixel electrodes is applied to the ions. Thus, the ions move in a lateral direction so that the ions accumulate in a boundary area between the pixel electrodes.

The ions reduce a permittivity of the liquid crystal layer and deteriorate a voltage holding ratio of the liquid crystal layer. As a result, an after-image appears on the screen, the after image being brighter or darker in the pixel boundary area than in the central pixel area.

### SUMMARY OF THE INVENTION

The present invention provides a display substrate which reduces an inflow of impurities into a liquid crystal layer.

The present invention also provides a display panel having the above-mentioned display substrate.

The present invention also provides a method of manufacturing the above-mentioned display substrate.

In one aspect of the present invention, a display substrate includes a base substrate and a color-converting layer. The base substrate includes a first surface and a second surface, the second surface being opposite to the first surface. The second surface faces a liquid crystal layer when the display substrate is applied to a display panel. The color-converting layer is formed on the first surface, and accordingly is disposed away from the liquid crystal layer. Light exiting from the color-converting layer has a wavelength different from a wavelength of a light incident into the color-converting layer.

For example, the color-converting layer includes a light-blocking pattern layer, a color filter layer and an overcoating layer. The light-blocking pattern layer is disposed at the first surface, and a plurality of openings is formed through the light-blocking pattern layer. The color filter layer is disposed at the first surface exposed through the openings. The overcoating layer covers the color filter layer and the light-blocking pattern layer. The display substrate may further include a transparent electrode layer, an alignment film and a spacer. The transparent electrode layer is disposed on the second surface. The alignment film covers the transparent electrode layer. The spacer is disposed on the alignment film. The display substrate may further include a phase delay compensating film and a polarizing plate. The phase delay compensating film is disposed on the overcoating layer. The polarizing plate is disposed on the phase delay compensating film. The color filter layer includes a polymer formed by exposing a negative color photoresist to light.

In another aspect of the present invention, a display panel includes an upper substrate, a lower substrate and a liquid crystal layer. The upper substrate includes an upper base substrate, a color filter layer and an overcoating layer. The upper base substrate includes a first surface and a second surface in opposite to the first surface. The color filter layer is disposed at a plurality of pixel areas defined at the first surface. The overcoating layer covers the color filter layer. The lower substrate includes a lower base substrate and a plurality of pixel electrodes. An upper surface of the lower base substrate faces the second surface. Each of the pixel electrodes is disposed on the upper surface to correspond to each of the pixel areas. The liquid crystal layer is disposed between the lower substrate and the upper substrate.

For example, the upper substrate may further include a light-blocking pattern layer. The light-blocking pattern layer is disposed at the first surface, and a plurality of openings to define the pixel areas is formed through the light-blocking pattern layer. The color filter layer is disposed at the first surface exposed through the openings. The upper substrate may further include a transparent electrode layer and an upper alignment film covering the transparent electrode layer. The lower substrate may further include a lower alignment film covering the pixel electrodes. The lower substrate may further include a first polarizing plate disposed at a lower surface facing the upper surface. The upper substrate may further include a second polarizing plate disposed on the overcoating layer.

In still another aspect of the present invention, a method of manufacturing a display substrate is provided. In the method, a light-blocking pattern layer having a plurality of openings is formed at a first surface of a base substrate. A color filter layer is formed at the first surface exposed through the openings. An overcoating layer is formed to cover the color filter layer. A transparent electrode layer is formed at a second surface of the base substrate, which is opposite to the first surface.

For example, an alignment film may be further formed on the transparent electrode layer. Furthermore, a spacer may be further formed on the alignment film. The color filter layer may be formed from a negative color photoresist formed at the first surface exposed through the openings.

According to the above, impurities such as ionic impurities may be prevented from flowing into a liquid crystal layer from a light-blocking pattern layer, a color filter layer, an overcoating layer, etc. Thus, an after-image having a linear shape due to an inversion driving may be reduced.

### BRIEF DESCRIPTION OF THE DRAWINGS

The above and other advantages of the present invention will become readily apparent by reference to the following detailed description when considered in conjunction with the accompanying drawings wherein:

FIG. 1 is a partial cross-sectional view illustrating a display substrate according to an exemplary embodiment of the present invention;

FIG. 2 is a partial plan view illustrating a display substrate according to another exemplary embodiment of the present invention;

FIG. 3 is a partial cross-sectional view taken along the line I-I′ of FIG. 2;

FIG. 4 is a partial plan view illustrating a display panel according to an exemplary embodiment of the present invention;

FIG. 5 is a partial cross-sectional view taken along the line II-II′ of FIG. 4;

FIG. 6 is a partial cross-sectional view illustrating a display panel according to another exemplary embodiment of the present invention; and

FIGS. 7A to 7D are cross-sectional views illustrating a method of manufacturing a display substrate according to an exemplary embodiment of the present invention.

### DESCRIPTION OF THE EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealize embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Display Substrate

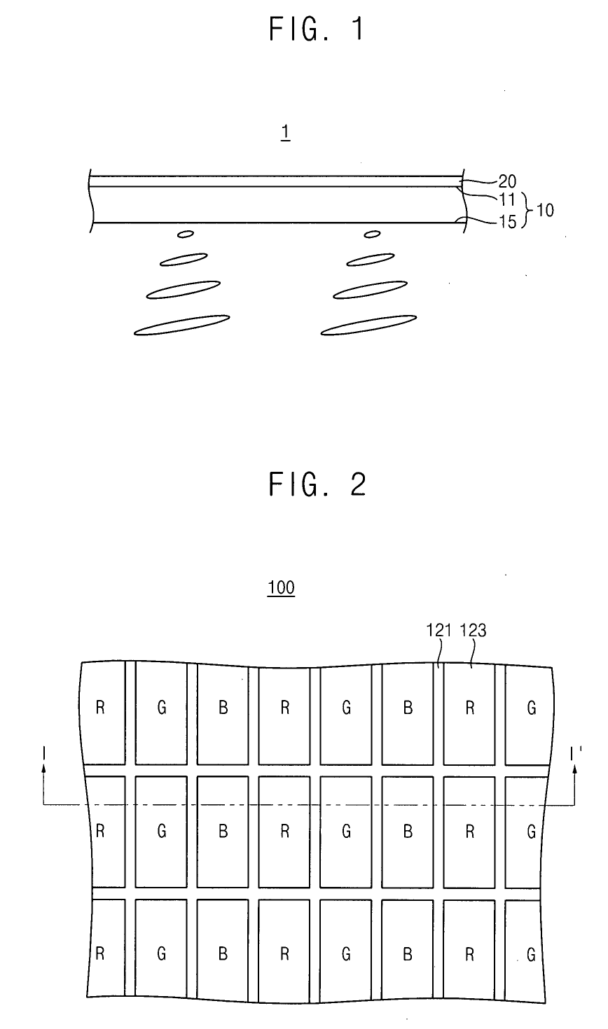

FIG. 1 is a partial cross-sectional view illustrating a display substrate according to an exemplary embodiment of the present invention.

A liquid crystal display panel includes an upper substrate, a lower substrate and a liquid crystal layer interposed between the upper substrate and a lower substrate. The upper substrate and the lower substrate face each other. In the liquid crystal display apparatus is operated according to an active matrix driving method, the lower substrate generally includes a plurality of pixel electrodes and a plurality of switching devices connected to the pixel electrodes. Furthermore, the upper substrate includes a plurality of color filters corresponding to the pixel electrodes and a transparent electrode layer covering the color filters.

A display substrate according to an exemplary embodiment of the present invention may be employed as the upper substrate or the lower substrate in the liquid crystal display panel.

Referring to FIG. 1, the display substrate 1 includes a base substrate 10 and a color-converting layer 20.

The base substrate 10 has a plate-shape and has a first surface 11 and a second surface 15. The second surface 15 is in opposite to the first surface 11. When the display substrate 1 is applied to the liquid crystal display panel, the second surface 15 faces a liquid crystal layer. The base substrate 10 may include glass having a relatively high transmittance and may be optically isotropic.

The color-converting layer 20 is formed at the first surface 11. Light exiting. from the color-converting layer 20 has a wavelength different from a light incident into the color-converting layer 20 to display a color. Particularly, a white light passes through a liquid crystal cell so that a transmittance of the white light is adjusted. The white light having passed through the liquid crystal cell passes through the color-converting layer 20 disposed on the liquid crystal cell. The color-converting layer 20 may include a red filter layer, a green filter layer and a blue color filter layer, which are disposed on the liquid crystal cell. The color may be displayed by additive color mixture of the light passing through the color-converting layer 20.

The color-converting layer 20 includes a pigment to display a color. The pigment includes organic particles having a relatively high light-resistance and a relatively high heat-resistance. The organic particles diffuse light. A transmittance and a diffusing characteristic of the color pigment increases as size of the organic particles decrease.

Since the color-converting layer 20 is formed at the first surface 11, the color-converting layer 20 is separated from the liquid crystal layer by the base substrate 10. Thus, impurities such as ionic impurities are prevented from flowing into the liquid crystal layer, because the liquid crystal contacts the base substrate on the side opposite the color converting layer 20.

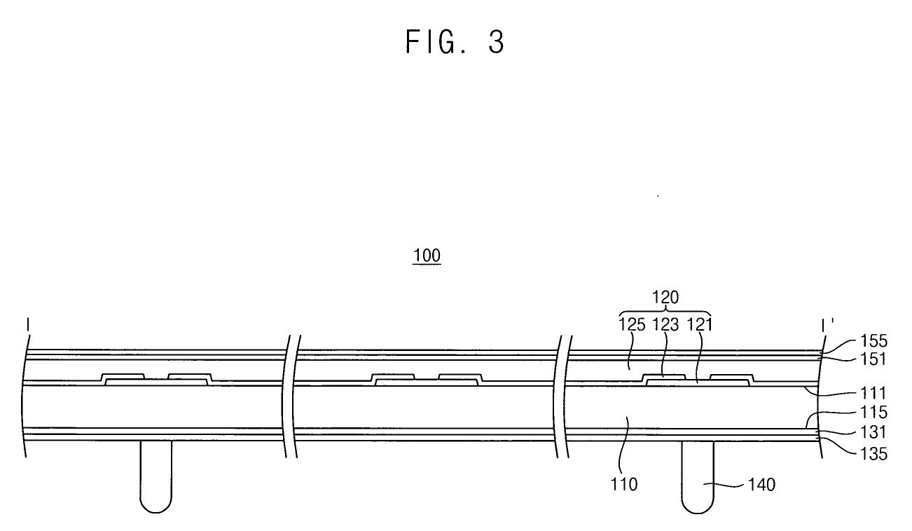

FIG. 2 is a partial plan view illustrating a display substrate according to another exemplary embodiment of the present invention. FIG. 3 is a partial cross-sectional view taken along the line I-I′ of FIG. 2.

Referring to FIGS. 2 and 3, a display substrate 100 includes a base substrate 110 and a color-converting layer 120.

The base substrate 110 is substantially the same as the base substrate illustrated in FIG. 2. Thus, the base substrate 110 includes a first surface 111 and a second surface 115 facing each other.

The base substrate 110 may include a transparent glass capable of transmitting light. When the glass is alkaline, alkaline ions may flow into a liquid crystal cell. Thus, light transmission through the liquid crystal so that display brightness is reduced. Furthermore, an adhesion between a sealant and the glass may be deteriorated, and operation of a thin film transistor (TFT) may be deteriorated. Thus, the base substrate 110 should preferably be made of non-alkaline glass.

Examples of a material that may be used for the base substrate 110 include triacetyl cellulose, polycarbonate, polyether sulfone, polyethylene terephthalate, polyethylene naphthalate, polyvinyl alcohol, polymethyl methacrylate, and cyclo-olefin polymer.

The color-converting layer 120 is formed at the first surface 111 to display a color. When white light passes through the liquid crystal cell the transmittance of the white light is changed based on the electric field between the common electrode and the pixel electrode. The white light having passed through the liquid crystal cell passes through the color-converting layer 120 disposed on the liquid crystal cell.

The color-converting layer 120 includes a light-blocking pattern layer 121, a color filter layer 123 and an overcoating layer 125 for protecting the color filter layer.

The light-blocking pattern layer 121 increases a contrast of a display screen. The light-blocking pattern layer 121 is disposed on the first surface 111 of the base substrate 110. Regions of the light-blocking pattern layer 121 are removed to expose first surface 111 thus providing a plurality of openings arranged in a matrix configuration. The exposed portions, or openings, are aligned with pixel areas. The light-blocking pattern layer 121 is disposed in a peripheral area of the pixel area, at which a light transmittance is prevented.

The light-blocking pattern layer 121 may include a metal such as chrome, of which an optical density is no less than about 3.5 or a carbon based organic material. When a chrome layer is used for the light-blocking pattern layer 121, a double layer of chrome/chrome oxide is formed to reduce a reflecting ratio thereof. The chrome oxide layer reduces reflection of peripheral light between the chrome layer and the base substrate 110. Thus, an effective contrast ratio of a display apparatus increases so that a display quality increases.

Light exiting from the color filter layer 123 has a wavelength different from a light incident on the color filter layer 123 through the second surface 115. The color filter layer 123 is disposed at the first surface 111 exposed through the opening formed at the light-blocking pattern layer 121. Thus, the color filter layer 123 corresponds to the pixel area and includes a red color filter part R, a green color filter part G and a blue color filter part B.

The red, green and blue color filter parts are arranged in a matrix configuration. Peripheral areas of the red, the green and the blue color filter parts R, G and B are overlapped with the light-blocking pattern layer 121. Referring to FIG. 2, the red, green and blue color filter parts R, G and B are arranged in a stripe configuration. Alternatively, the red, green and blue color filter parts are arranged in a mosaic configuration or a delta configuration.

The white light which passes through the red, green and blue color filter parts R, G and B to be converted to red light, green light and blue light. A color is displayed by additive color mixture of the red, green and blue lights.

The color filter layer 123 may be formed by a pigment method or dye method depending on the material used for the color filter layer 123. Based on the manufacturing method the color-filter may be formed by a dying method, a pigment dispersing method, an adehesion method, or a printing method manufacturing process of color filter layer 123.

When the color filter layer 123 is formed by a pigment dispersing method, a color photoresist used for the color filter layer 123 may include a pigment to display a color, a photo-polymerization initiator, a monomer, a binder as a conventional photoresist.

The photopolymerization initiator is a highly optically sensitive compound which generates a radical. The monomer is polymerized by the radical to form a polymer unsoluable in a developing solution. For example, the color filter layer 123 may be formed by using a negative color photoresist.

The binder keeps the monomer in a liquid phase at a general temperature from a developing solution and affects stabilization of pigment dispersion, a heat-resistance, a light-resistance and a chemical resistance of each of the red, green and blue color filter parts R, G and B. The pigment may be an organic particle having a high light-resistance and a heat-resistance to diffuse an incident light.

The overcoating layer 125 covers the color filter layer 123 and the light-blocking pattern layer 121 to protect the color filter layer 123 and the light-blocking pattern layer 121. Additionally, the overcoating layer 125 compensates for a height difference between the color filter layer 123 and the light-blocking pattern layer 121 to planarize a surface of the display substrate 100. The overcoating layer 125 may include a material having a high transmittance and a hardness enough to protect the color filter layer 123 and the light-blocking pattern layer 121. Particular examples of a material that may be used for the overcoating layer 125 include an acryl resin, a polyamide resin, and a polycarbonate resin.

Alternatively, the overcoating layer 125 may be omitted if the red, green and blue color filter parts R, G and B overlap above the light-blocking pattern layer 121.

The display substrate 100 may further include a transparent electrode layer 131, an alignment film 135 and a spacer 140.

The transparent electrode layer 131 provides an electrode to form an electric field applied to a liquid crystal layer. The transparent electrode layer 131 is disposed at the second surface 115 of the base substrate 110. The transparent electrode layer 131 may be formed over the whole portion of the second surface 115. Examples of materials that may be used for the transparent electrode layer 131 include a transparent conducting material such as indium-tin-oxide, indium-zinc-oxide, and indium-tin-zinc-oxide.

The alignment film 135 is a thin film of a polymer compound, which is rubbed in a predetermined direction and is disposed on the transparent electrode layer 131. The alignment film 135 may include polyimide as a major component in view of an alignment stability of a liquid crystal, a durability and a productivity. Since the alignment film 135 affects an electric field formed by the transparent electrode layer 131, the alignment film 135 may preferably have a thickness as small as possible.

The spacer 140 maintains a cell gap between the display substrate 100 and a counter substrate by a predetermined distance. For example, the spacer 140 may be a column spacer and may be formed on the alignment film 135 with a predetermined density to correspond to the light-blocking pattern layer 121. When the display panel employs a ball spacer, the spacer 140 of the display substrate 100 may be omitted.

The display substrate 100 may further include a phase delay compensating film 151 and a polarizing plate 155.

The phase delay compensating film 151 is disposed on the overcoating layer 125. The phase delay compensating film 151 retards a phase of an incident light by a quarter of a wavelength of the incident light. The polarizing plate 155 is disposed on the phase delay compensating film 151.

Display Panel

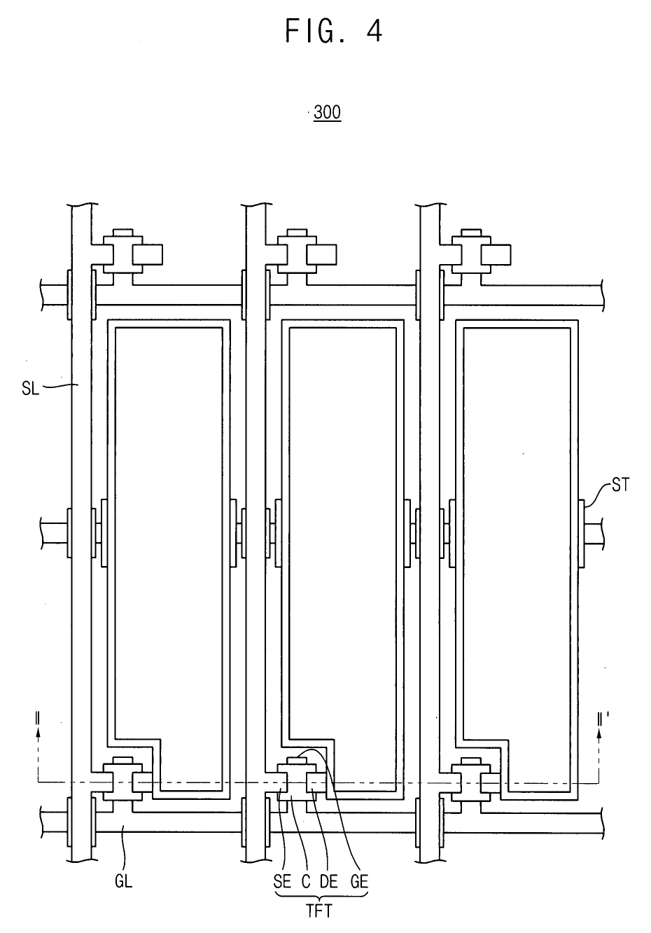

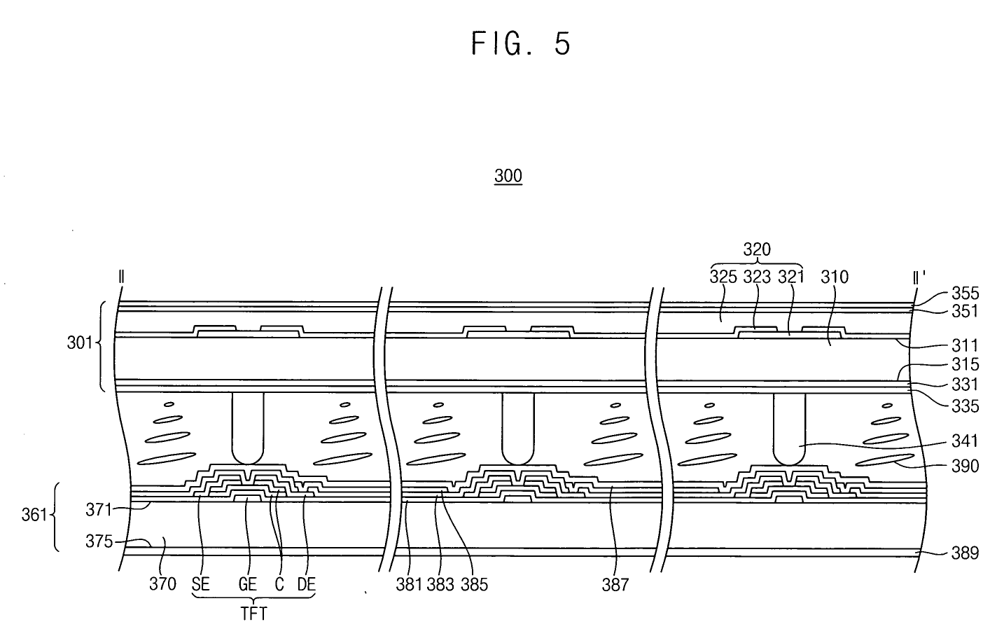

FIG. 4 is a partial plan view illustrating a display panel according to an exemplary embodiment of the present invention. Particularly, a lower substrate is illustrated without the upper substrate. FIG. 5 is a partial cross-sectional view taken along the line II-II′ of FIG. 4 but with the upper substrate in place.

Referring to FIGS. 4 and 5, a display panel 300 includes an upper substrate 301, a lower substrate 361 and a liquid crystal layer 390.

The upper substrate 301 is substantially the same as the display substrate 100 illustrated in FIGS. 2 and 3. The upper substrate 301 includes an upper base substrate 310, a light-blocking pattern layer 321, a color filter layer 323, an overcoating layer 325, a phase delay compensating film 351, a first polarizing plate 355, a transparent electrode layer 331, an upper alignment film 335 and a spacer 341.

The upper base substrate 310 includes a first surface 311 and a second surface 315 which is opposite to the first surface 311. The light-blocking pattern layer 321 is disposed at the first surface 311. Thereafter a plurality of regions of the light blocking layer 321 are removed to expose regions on surface 311, these exposed regions being aligned with a plurality of pixel areas. Hereinafter the exposed regions are sometimes referred to as being openings in the light-blocking layer. The color filter layer 323 is disposed at the first surface 311 and exposed through the openings. The overcoating layer 325 covers the color filter layer 323. The phase delay compensating film 351 and the first polarizing plate 355 are sequentially deposited on the overcoating layer 325.

The transparent electrode layer 331 and the upper alignment film 335 are deposited in turn at the second surface 315. The spacer 341 is formed on the upper alignment film 335 corresponding to the light-blocking pattern layer 321.

The lower substrate 361 includes a lower base substrate 370 and a plurality of pixel electrodes 385.

The lower base substrate 370 includes an upper surface 371 and a lower surface 375 facing the upper surface 371. The lower base substrate 370 may include a non-alkaline glass substantially same as the upper base substrate 310. The upper surface 371 faces the second surface 315. The pixel electrodes 385 are disposed at the upper surface 371 corresponding to the pixel areas.

Referring to FIG. 4, the lower substrate 361 may further include a plurality of source lines SL, a plurality of gate lines GL, a plurality of storage common lines ST, a plurality of switching devices such as TFTs and as shown in FIG. 5, a passivation layer 383 and a lower alignment film 387.

The source lines SL, the gate lines GL and pixel areas defined by the source lines SL and the gate lines GL are formed at the lower base substrate 370.

The storage common lines ST and the switching devices are formed in the pixel areas. The switching devices are electrically connected to the source lines SL and the gate lines GL.

Examples of a material that may be used for the pixel electrodes 385 include a transparent conducting material such as indium-tin-oxide, indium-zinc-oxide, and indium-tin-zinc-oxide.

The switching device includes a gate electrode GE electrically connected to the gate line GL, a source electrode SE electrically connected to the source line SL and a drain electrode DE electrically connected to the pixel electrode 385. A channel layer C is formed between the gate electrode GE and the source electrode SE, and between the gate electrode GE and the drain electrode DE.

Gate insulating layer 381 is formed on the gate line GL, the storage common line ST and the gate electrode GE. A passivation layer 383 is formed on the source line SL, the source electrode SE and the drain electrode DE. A contact hole is formed through the passivation layer 383 so that the pixel electrode 385 is electrically connected to the drain electrode DE exposed through the contact hole.

A lower alignment film 387 is formed on the passivation layer 383. The light-blocking pattern layer 321 is patterned to be overlapped with the source lines SL.

The liquid crystal layer 390 between the upper substrate 301 and the lower substrate 361 is initially aligned in a predetermined direction. An alignment angle of the liquid crystal layer 390 is varied in response to a voltage difference between the pixel electrodes 385 and the transparent electrode layer 331 so that the display panel 300 displays an image.

The lower base substrate 361 may further include a second polarizing plate 389 disposed on the lower surface 375 facing the upper surface 371.

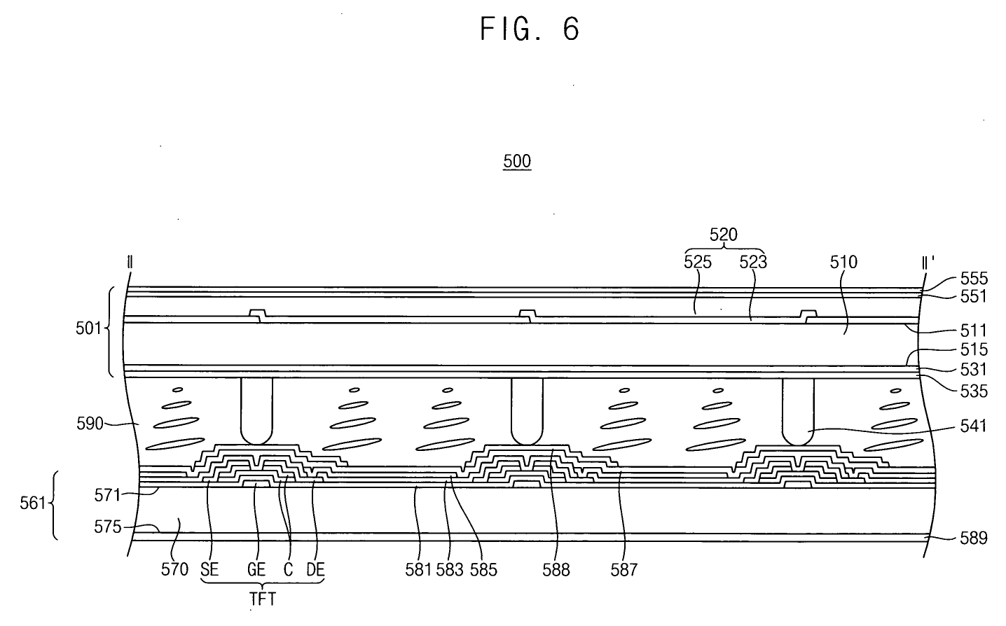

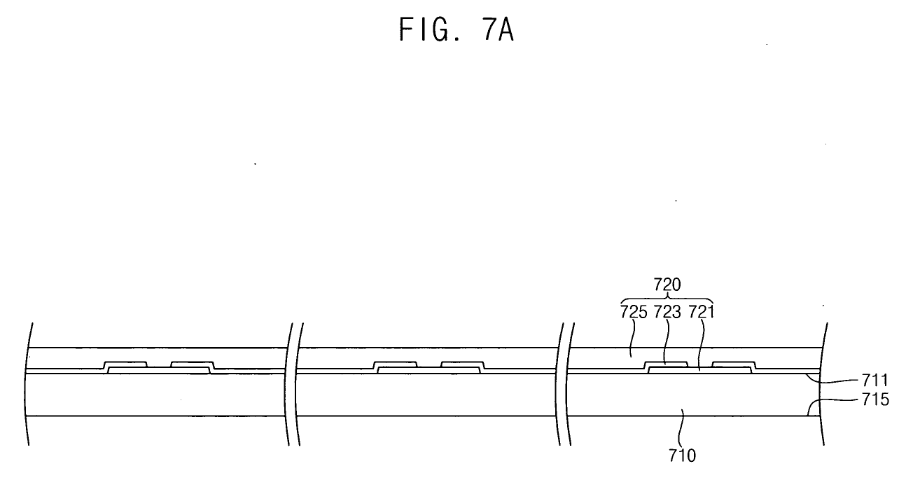

FIG. 6 is a partial cross-sectional view illustrating a display panel according to another exemplary embodiment of the present invention.

Referring to FIG. 6, a display panel 500 includes an upper substrate 501, a lower substrate 561 and a liquid crystal layer 590.

The upper substrate 501 includes an upper base substrate 510, a color filter layer 523, an overcoating layer 525, a phase delay compensating film 551, a first polarizing plate 555, a transparent electrode layer 531, an upper alignment film 535 and a spacer 541.

The upper substrate 501 is substantially the same as the upper substrate 301 illustrated in FIGS. 4 and 5 except that a light-blocking pattern layer is omitted. The color filter layer 523 includes a red filter part, a green filter part and a blue color filter part. Edge portions of the color filter parts are overlap each other.

The lower substrate 561 is substantially the same as the lower substrate 361 illustrated in FIG. 4 and 5 except for further including a light-blocking pattern layer 588. The light-blocking pattern layer 588 is disposed on the lower alignment film 587. The light-blocking pattern layer 588 is patterned to cover the source lines and gate lines.

Method of Manufacturing a Display Substrate

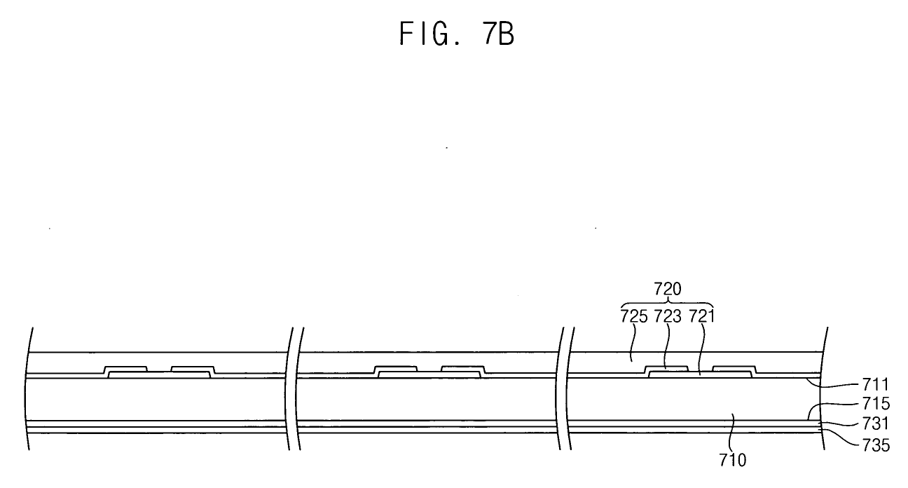

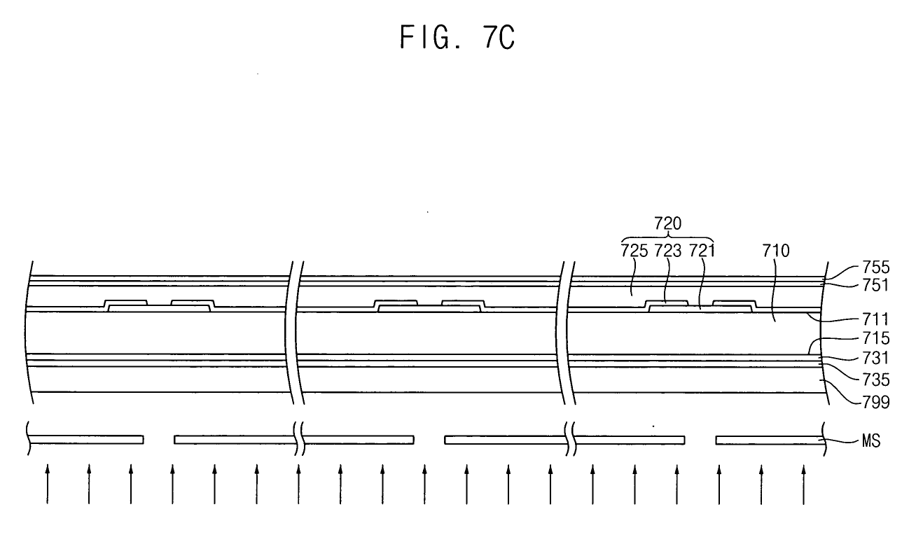

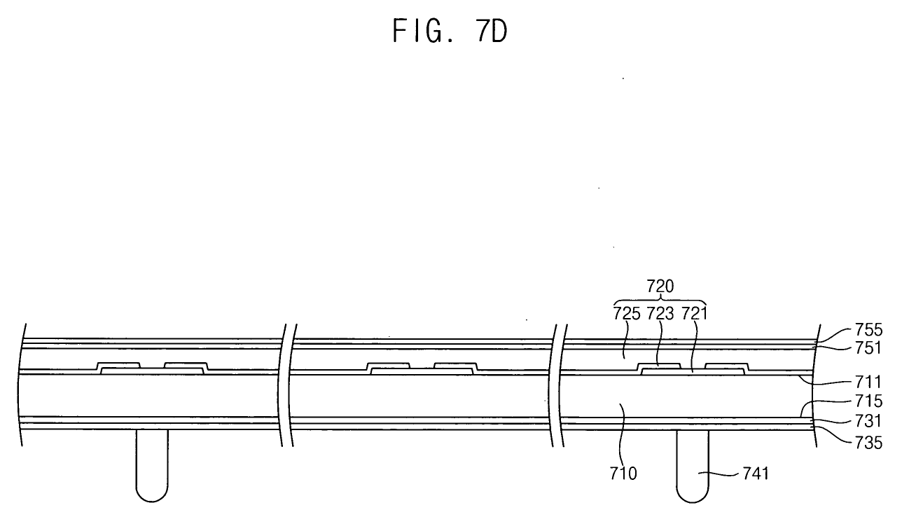

FIGS. 7A to 7D are cross-sectional views illustrating a method of manufacturing a display substrate according to an exemplary embodiment of the present invention.

Referring to FIGS. 7A to 7D, a method of manufacturing a display substrate includes a step of forming a light-blocking pattern layer 721 having a plurality of openings at a first surface 711 of a base substrate 710, a step of forming a color filter layer 723 on the first surface 711 exposed through the openings, a step of forming an overcoating layer 725 that covers the color filter layer 723 and a step of forming a transparent electrode layer 731 at a second surface 715 of the base substrate 710, which is in opposite to the first surface 711.

Referring to FIG. 7A, a thin film which may be comprised of, for example, a chrome layer, a chrome/chrome oxide layer, or a carbon based layer is formed on the first surface 711 of the base substrate 710 through a sputtering process. The thin film is patterned through a photo-lithography process and a chrome wet-etching process using a mask having a light-blocking pattern to form the light-blocking pattern layer 721. As a result, the light-blocking pattern layer 721 having a plurality of openings corresponding to a plurality of pixel areas is formed on the base substrate 710.

The color filter layer 723 is formed at the first surface 711, on which the light-blocking pattern layer 721 is formed, through a pigment method, or a dye method as described above. In this embodiment, the color filter layer 723 is formed through the pigment method that secures a color resin having a pigment as a color pattern. Alternatively, the color filter layer 723 can be formed through the dye method that dyes a color pattern using a dye.

The color filter layer 723 is formed on the first surface 711 exposed through the openings by using a negative color photoresist. Particularly, the negative color photoresist, in which red pigments are dispersed, is coated on the first surface 711, on which the light-blocking pattern layer 721 is disposed. The negative color photoresist is exposed to light by using a mask. As a result, a photo-polymerization initiator of the negative color photoresist exposed to the light reacts so that a polymer is formed. The polymer is not removed through a developing process to form a red color filter part. After the developing process, the red color filter part is heated to secure it in place. The green and the blue color filter parts are formed through substantially the same as the above processes.

The overcoating layer 725 is formed on the light blocking pattern layer 721 and the color filter layer 723 by coating an acryl resin, or polyamide resin, a polycarbonate resin. Referring to FIG. 7B, the transparent electrode layer 731 and the alignment film 735 are formed at the second surface 715 of the base substrate 710. Particularly, the transparent electrode layer 731 is formed by depositing a layer including a transparent conductive material such as indium-tin-oxide, indium-zinc-oxide, or indium-tin-zinc-oxide through a sputtering process. After rinsing the base substrate 710 including the transparent electrode layer 731, a polyimide film 735 is printed on the transparent electrode layer 731. The polyimide film is dried, baked and rubbed by a process well known in the art to form the alignment film. When the hardness of the alignment film 735 is relatively great, impurities such as ionic impurities are effectively prevented from flowing into a liquid crystal layer. However, when the hardness of the alignment film 735 is relatively great, the alignment film 735 may not have a uniform thickness. In this embodiment, the light-blocking pattern layer 721, the color filter layer 723 and the overcoating layer 725 are formed at the first surface 711 without making contact with the liquid crystal layer. Therefore, although the hardness of the alignment film 735 is small enough to form alignment film 735 having a uniform thickness, the impurities may be prevented from flowing into the liquid crystal layer.

Referring to FIGS. 7C and 7D, a layer resin 799 is coated on the alignment film 735 and is patterned through a photo-lithography process using mask MS to form the spacer 741 positioned below the light-blocking pattern layer 721. In the photo-lithography process, the color filter layer 723 may be exposed to light. However, since the color filter layer 723 is formed by using a negative color photoresist, the color filter layer 723 is not damaged.

After the spacer 741 is formed, a phase delay compensating film 751 may be formed on the overcoating layer 725, and a polarizing plate 755 may be formed on the phase delay compensating film 751. Phase delay compensating film 751 may be of the same type as phase delay compensating film 151 described above in connection with FIG. 3.

According to the above, a light-blocking pattern layer, a color filter layer and an overcoating layer are formed at a first surface of a base substrate, and a liquid crystal layer makes contact with an alignment film formed on a second surface of the base substrate, which is in opposite to the first surface. Thus, the liquid crystal layer is separated from the light-blocking pattern layer, the color filter layer and the overcoating layer. Therefore, impurities such as ionic impurities may be prevented from flowing into the liquid crystal layer.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed is:

1. A display substrate comprising:
a base substrate having a first surface and a second surface opposite the first surface;
a color-converting layer formed on the first surface; and
a liquid crystal layer positioned adjacent to the second surface of the base substrate.

2. The display substrate of claim 1, wherein the color-converting layer comprises:
a light-blocking pattern layer disposed on the first surface, the light-blocking pattern layer having a plurality of openings;
a color filter layer disposed at the first surface exposed through the openings; and
an overcoating layer that covers the color filter layer and the light-blocking pattern layer.

3. The display substrate of claim 1, further comprising a transparent electrode layer positioned on the second surface of the base substrate.

4. The display substrate of claim 3, further comprising:
an alignment film positioned on the transparent electrode layer.

5. The display substrate of claim 4, further comprising a spacer disposed on the alignment film.

6. The display substrate of claim 5, wherein a position of the spacer is aligned with a portion of the light-blocking pattern layer.

7. The display substrate of claim 2, further comprising a phase delay compensating film disposed on the overcoating layer.

8. The display substrate of claim 7, further comprising a polarizing plate disposed on the phase delay compensating film.

9. The display substrate of claim 2, wherein the color filter layer comprises a polymer formed by exposing a negative color photoresist to a light.

10. A display panel comprising:
an upper substrate comprising an upper base substrate having a first surface and a second surface opposite to the first surface, a color filter layer disposed in a plurality of pixel areas defined on the first surface and an overcoating layer that covers the color filter layer;
a lower substrate comprising a lower base substrate having an upper surface facing the second surface and a plurality of pixel electrodes disposed at the upper surface, wherein each of the pixel electrodes is aligned with an associated pixel area; and
a liquid crystal layer positioned between the second surface of the upper substrate and the lower substrate.

11. The display panel of claim 10, wherein the upper substrate further comprises a light-blocking pattern layer disposed on the first surface, the light-blocking pattern layer having a plurality of openings defining each of the pixel areas,
and wherein the color filter layer is disposed on the first surface exposed through the openings.

12. The display panel of claim 11, wherein the upper substrate further comprises an upper alignment film covering the transparent electrode layer, and
the lower substrate further comprises a lower alignment film positioned on the pixel electrodes.

13. The display panel of claim 12, wherein the lower substrate further comprises a first polarizing plate disposed on a lower surface in opposite to the upper surface; and
the upper substrate further comprises a second polarizing plate disposed on the overcoating layer.

14. The display panel of claim 10, wherein the lower substrate further comprises a light-blocking pattern layer formed between the pixel electrodes.

15. A method of manufacturing a display substrate comprising:
forming on a first surface of a substrate a light-blocking pattern layer having a plurality of openings;
forming a color filter layer on the first surface, wherein the color filter layer is exposed through the openings;
forming an overcoating layer on the color filter layer; and
forming a transparent electrode layer on a second surface of the substrate opposite the first surface.

16. The method of claim 15, further comprising:
forming an alignment film on the transparent electrode layer.

17. The method of claim 15, wherein forming a color filter layer is performed by forming a negative color photoresist on the first surface exposed through the openings.

18. The method of claim 16, further comprising forming at least one spacer on the alignment film.

19. The method of claim 15, further comprising forming a phase delay compensating film on a surface of the overcoating layer.

20. The method of claim 19, further comprising forming a polarizing plate on a surface of the phase delay compensating film.
